(19) United States
(12) Patent Application Publication
(10) Pub. No.: US 2020/0066015 A1
(43) Pub. Date: Feb. 27, 2020

(54) METHOD FOR CREATING GRIDDED REFERENCE GRAPHICS

(71) Applicant: Ethan P. Killeen, Dresher, PA (US)

(72) Inventor: Ethan P. Killeen, Dresher, PA (US)

(21) Appl. No.: 16/113,895

(22) Filed: Aug. 27, 2018

(51) Int. Cl. G06T 11/60; G06T 7/73; G06T 3/00

(52) U.S. Cl. CPC G06T 11/60; G06T 7/73; G06T 2207/20221; G06T 2207/10032; G06T 2207/30181; G06T 3/0068

(57) ABSTRACT

A method for creating GRG for use in geospatial information systems and geospatial intelligence software solutions. The method includes creating a high resolution raster working image from a more complicated and sizable GIS source image. The working image is stripped of the embedded or associated meta data and can be easily imported and manipulated within conventional graphic editing and creation software. Geographic anchor points are selected and marked on separate graphic layers of the working image, along with additional graphics and annotations, and saved as a master image. The master image is exported back into the GIS platform using the anchor point markers to align the overlying master images with the original source image. Meta data from the source image is re-associated with the master image and saved as a final image.

This invention relates to a method for creating gridded reference graphics, and in particular, a method for annotated orthophotomaps for use as gridded reference graphics in geospatial intelligence software solutions.

### BACKGROUND AND SUMMARY OF THE INVENTION

BAE Systems Information and Electronic Systems Integration, Inc. of Nashua, N.H. (“BAE”) has developed advanced geospatial intelligence software solutions for visual, real-time coordination and identification of personnel within given locations within a geographic information system (“GIS”). BAE markets this software solution as SOCET SET® and SOCET GXP®, which provides coordinating location information using specialized orthophotomaps of specific locations. These specialized orthophotomaps are annotated with a grid overlay created using a method disclosed in U.S. Pat. No. 9,830,726 (“Deitrich”). Using the patented method, a grid is digitally imposed onto an orthorectified source GIS image of a location from satellite and aerial sources, along with annotations, labels, legends and additional graphics reflecting relevant information and structures to create a gridded reference graphic or “GRG.” The GIS platform then distributes and displays the GRG on user devices and continuously updates the information regarding the location and movements of specific personnel on the displayed GRG. While a powerful intelligence coordination and operational tool, these types of software solutions remain dependent on accurate and detailed orthophotomaps and GIS images that contain large amounts of geospatial information for a given location.

BAE was also among the first to make available commercial digital photogrammetry software programs that can create GIS images and orthophotomaps. Prior to the development of commercial digital solutions, photogrammetry programs were primarily analog or custom systems built for government agencies. While digital photogrammetry software programs are now commercially available, such as the software for creating GIS images, orthophotomaps and GRGs remain complex and cumbersome.

Much of the complexity and cumbersomeness is found in annotating the digital GIS source images. GIS images contain large quantities of geospatial data and information (“geometa data”). The size of these digital GIS image files slows rendering and distribution. In addition, such software lacks many of the illustration tools and conventions to quickly and adequately annotate and enhance the GIS source images to create GRGs practical for use in the field.

### SUMMARY OF INVENTION

The present invention concerns a method for quickly and conveniently creating GRG for use in geospatial information systems and geospatial intelligence software solutions. The method includes creating a high resolution raster or “dumb” working image from a more complicated and sizable GIS source image. The working image is typically created using the print screen function within the GIS platform. The working image is stripped of the embedded or associated meta data and can be easily imported and manipulated within conventional graphic editing and creation software, such as Adobe Illustrator or Photoshop. Once the working image is imported into a conventional graphic editor, geographic anchor points are selected and marked on separate graphic layers of the working image and saved as a master image. Additional graphic layers are created and imposed onto the master image containing other additional graphics and annotations, such as imported floor plans, route highlights, site features, comments, and grids. The master image is exported back into the GIS platform using the anchor point markers to align the overlying master images with the original source image. Once properly aligned, the meta data from the source image is re-associated with to the master image and saved as a final image, ready to be used as a GRG within the GIS platform having full geospatial functionality within the GIS.

The method reduces the complexity and difficulty of creating, editing and manipulating large GIS image files within conventional GIS platforms, and utilizes the extensive, but commonly used, tools of conventional graphic software to streamline GRG creation. By creating a “dumb” image from a more complicated and sizable GIS source image, which can be easily imported and manipulated within convention graphic editing and creation software, graphics and annotation can be easily incorporated with faster rendering times. In addition, the use of conventional graphic software provides more tools and greater flexibility in creating enhancement graphics and annotations for GRGs than found in the more cumbersome GIS platforms. Once the “dumb” image is fully enhanced, the resulting master image can be exported back into the GIS and the geospatial metadata from the source image mapped into the master image creating the GRG having full functionality within the GIS.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is a flow chart of the method of this invention;

FIG. 2 is a screen shot taken from a typical GIS platform showing an exemplary source image for use with the method of this invention;

FIG. 3 is an exemplary high resolution source image obtained by a screen shot from the GIS platform;

FIG. 4 is an exemplary working image cropped and framed from the source image of FIG. 3;

FIG. 5 is an exemplary master image generated from the working image of FIG. 4;

FIG. 6 is an exemplary graphic layer of the master image of FIG. 5 depicting an imported floor plan for the first floor of the depicted school shown in FIG. 4;

FIG. 7 is an exemplary graphic layer of the master image of FIG. 5 depicting an imported floor plan for the second floor of the depicted school shown in FIG. 4;

FIG. 8 is an exemplary graphic layer of the master image of FIG. 5 depicting an imported floor plan for the basement of the depicted school shown in FIG. 4;

FIG. 9 is an exploded view of each of the transparent graphic layers of FIGS. 6-8 superimposed directly over master image of FIG. 5;

FIG. 10 is an exemplary final image generated from the master image of FIG. 5;

FIG. 11 is an illustration of the linking of final images and their associated sidecar files within a GIS platform; and

FIG. 12 is an exemplary screen shot of a GIS platform display showing the final image as a GRG.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

The following is a glossary of terms as used in the description of the preferred embodiment:

Anchor Point—geospatial feature of structure, fixture or natural object within graphic image used to orient and scale Source Images and Working Image.

Export/Import—Transfer and/or convert an electronic file from one software platform or application to another.

Final Image(s)—The enhanced Master Image will all embedded Graphic Layers containing Structures, Routes & Passages, Critical Element Layers, Label & Comment, and other annotations.

Geospatial Information Systems or GIS—Software platform for developing, editing, managing, displaying and distributing geospatial graphic images.

GIS Image(s)—Images consisting of orthophotographs and its encoded geographic information (the “geospatial meta data”).

Gridded Reference Graphic(s) or GRG(s)—an orthophotomap having a grid and other graphic information overlaid on an orthophotographic image created from the integratation of the Final Image and Supplemental Files of associated geospatial metadata ready for use in GIS.

Master Image—Edited Working image containing Anchor Points and additional information and annotated graphic layer.

Source Image—GIS image of a given location

Supplemental File or Sidecar File(s)—an associated digital file of the Source Image containing geospatial meta data relating to the source image location. Connected files that store data (often metadata) which is not supported by the source file format. For each source file one or more sidecar files can be created.

Supplemental Image(s)—Edited Working image containing Anchor Points and alternative additional information and annotated graphic layer related to the Master image.

Working Image(s)—a high resolution copy of source image stripped of geospatial meta data, generally captured as a screen print in a .png, .jpg and other similar file formats.

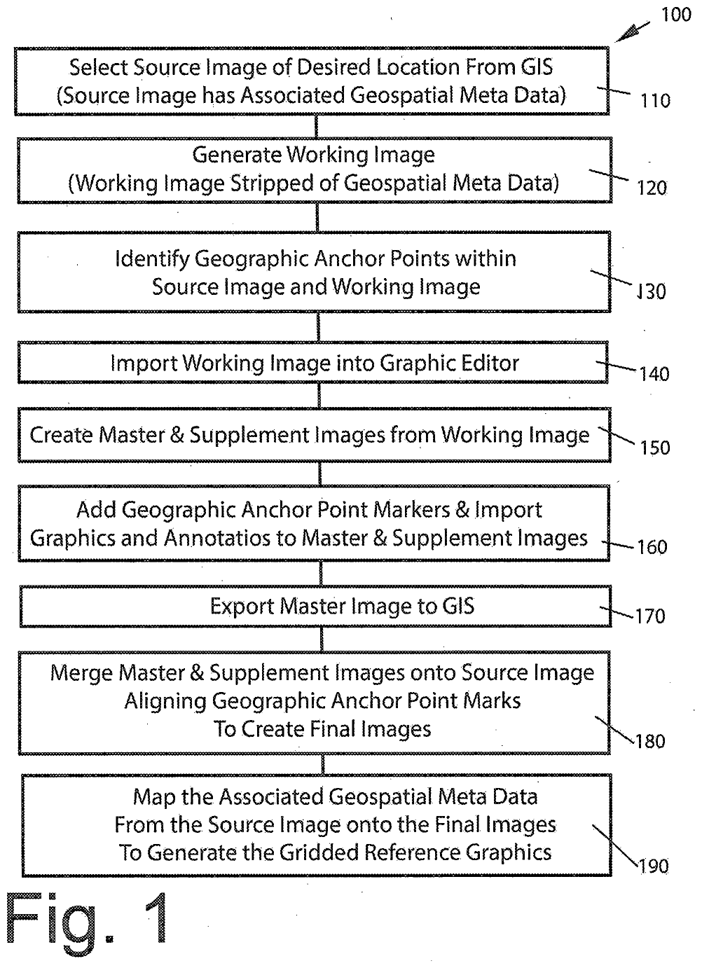

Referring now to the drawings, FIG. 1 illustrates a flow chart describing the method, designated generally as reference numeral 100, for annotating orthophotomaps for use as gridded reference graphics (“GRGs”) in geospatial information systems and geospatial intelligence software solutions. Method 100 is designed to enhance and speed GRG creation for use in intelligence software solutions, such as BAE's Socet GPX®. Method 100 uses conventional computer hardware and graphic editing software to create auxiliary image files that can be integrated with geospatial meta data from source GIS images within the host GIS software platform. As such, method 100 of this invention incorporates conventional computer hardware and software use and manipulation conventions and techniques. Such conventions and techniques include: file naming and saving; format conversion; file import/export; file and object copy, cut and paste; and meta data display and editing. Such computer conventions and techniques are commonly understood and known in the art.

The method begins with selecting a source image of a desired location (Step 110). Source images are GIS images consisting of orthophotographs and associated geographic information (the “geospatical meta data”). Generally, the geospatial meta data can be encoded or embedded directly into the digital image file or contained in an associated sidecar file. The orthophotographs are geometrically corrected (“orthorectified”) to eliminate “stretch” distortion and have uniform scale. Geospatial meta data includes spatio-temporal (space-time) locations as the key index variable for all other associated information. Spatial locations are recorded as x, y, and z coordinates representing, longitude, latitude, and elevation, respectively. In addition, the geospatial meta data may also include representations of other quantified systems of spatial-temporal reference, for example: roads, buildings, utility fixtures, highway mile-markers, surveyor benchmarks, building addresses, street intersections, entrance gates, fences, waterways, etc. . . . . The GIS images and the encoded geospatial metadata are standardized under ISO/TC 221 of the International Standards of Technical Specifications. Source images may be obtained from various sources, such as the United States Geological Survey (“USGS”), National Geospatial-intelligence Agency (“NGA”) and various GIS software developers.

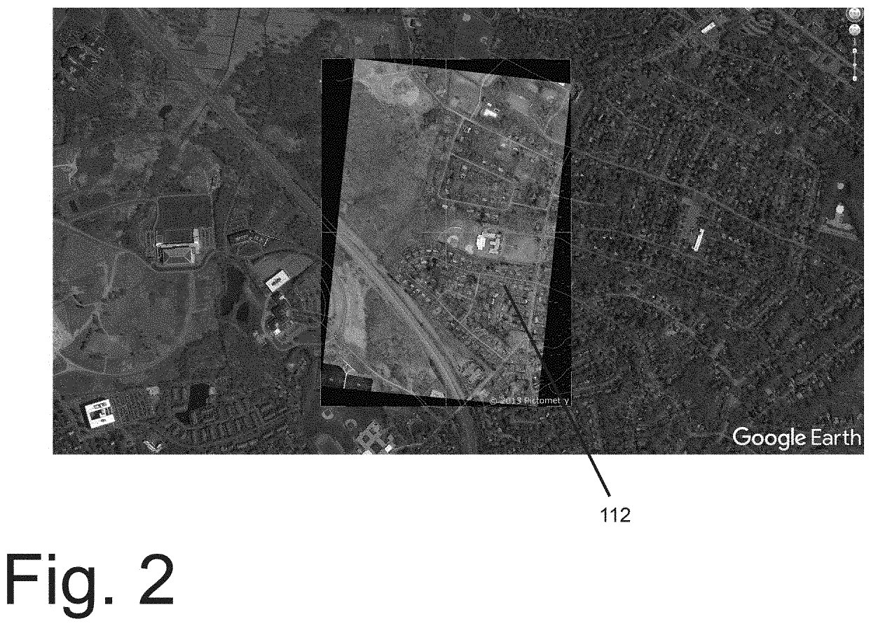

FIG. 2 illustrates an exemplary source image 112 for a hypothetical location. FIG. 2 is a screen shot taken from a typical GIS platform, in this instance, Google Earth. Google Earth is a GIS platform available from Alphabet, Inc. in Mountain View, Calif. Google Earth provides a variety of GIS tools to view and manipulate a source image within the platform. Source image 112 is an orthophotograph of an unidentified school grounds taken from an independent image source, in this instance Pictometry International Corporation of Henrietta, N.Y., and imported into Google Earth. As shown, source image 112 is a photographic depiction of a school building, various ancillary buildings, outdoor walkways, drive ways, parking lots, roadways and sports fields. Source image 112 depicts natural and geographic features of the school grounds, such as trees, grassy areas, fields, hills, streams, ravines and the like. Source image 112 may also depict visible utility and municipal features, such as fences, power lines, utility poles, hydrants, road signs and markers.

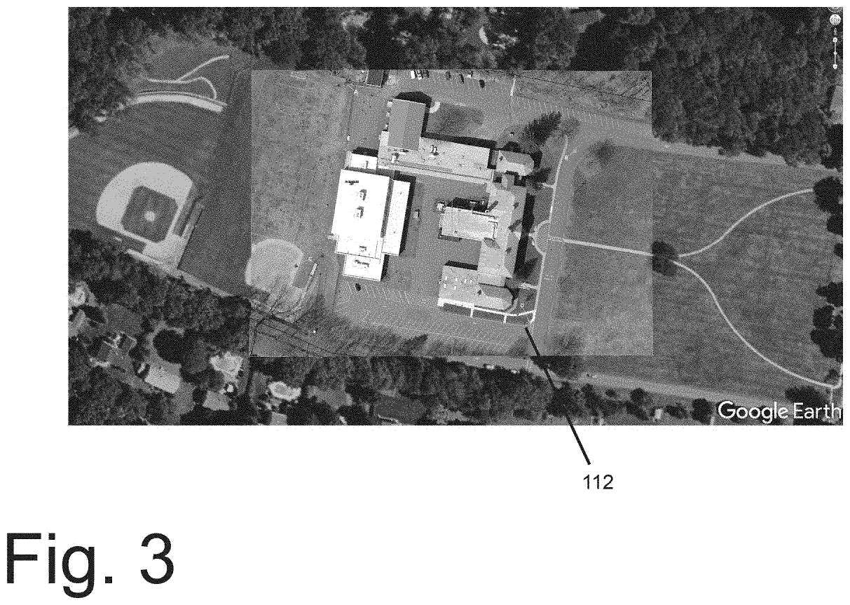

Referring back to FIG. 1, the next step is to generate a working image 122 from source image 112 (Step 120). Working image 122 is “dumb” image copied from source image 112 and stripped of the encoded geospatial meta data. Typically, working image 122 is a high resolution raster graphic obtained by a screen print of source image 112 within the GIS platform, exactly duplicating photographic depictions of the source image. The screen shot process is a common and well known feature or tool found in computer operating systems and available in most GIS platforms, that creates a raster image of the displayed graphics of the computer system. Working image 122 is saved in a common raster graphic format, such as a .gif, .png, or .jpg file. While maintaining the same geographic depictions of source image 112 in a high resolution format, working image 122 is a “dumb” image lacking the encoded geospatial meta data, or any direct mapping to any associated meta data sidecar files. Moreover, working image 122 is generally a significantly smaller file size than source image 112. FIG. 3 illustrates an exemplary working image 122 created from source 112 by taking a “screen shot” from within Google Earth.

Referring back to FIG. 1, the next step is to identify geographic anchor points within source image 112 and working image 122 (Step 130). Typically, four separate anchor points are selected within the source image, usually one in each quadrant of source image 112 and working image 122. The geographic anchor points will be marked on working image 122 used to orient and align overlying, such various final images ultimately created by the methodology of this invention with source image 112 within the intended GIS platform. Generally, discrete features of structures, fixtures, landscape and other permanent fixed geographic features are selected as geographic anchor points. For example, a corner of a building, a fire hydrant or tree trunk may all be used as an anchor point. As shown in Fig. B1, four geographics anchor points are selected in working image 122 for illustration purposes: the corner fence post shown in the upper left corner A; the tip of the arrow painted in the driveway in the upper right corner B; the corner of the sidewalk in the lower right corner C; and the first base of the baseball field in the lower left corner D.

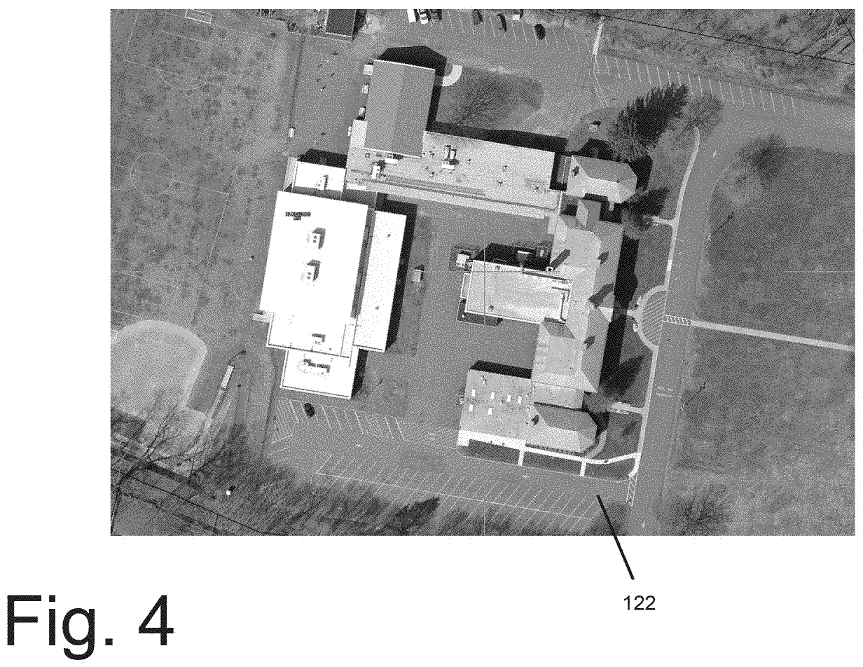

The next step is to import working image 122 into a conventional graphic software program (“graphic editor”) having layering capabilities (Step 140). Graphic editing and creation software, such as Illustrator and Photoshop available from Adobe Systems Incorporated of San Jose, Calif. are ideal graphic editors for receiving work image 122. Both Illustrator and Photoshop are well known graphic editing and creation software having layering capabilities and editing and illustration tool sets that are extensive but easily used. The layering capabilities include the ability to selectively embed, edit, lock, delete, display or hide nearly unlimited numbers of layers within a given graphic image. Once working image 122 is imported into the vector graphics editor, working image 122 is cropped and framed to the desired size and used in the intended GIS system. As shown in FIG. 4, working image 122 is generally framed to the size of source image 112, but may be framed to accommodate display size and resolution requirements of user displays within the GIS system.

The next step is to create a master image 152 from working image 122 (Step 150). Master image 152 contains at least one overlying transparent graphic layer 154 created using the layering capabilities of the graphic editing and creation software. Transparent graphic layer 154 is added to working image 122 over the photographic depictions thereof. Using the graphic editing and creation image software, additional graphics and annotations can be easily added, imported and edited into one or more graphic layer 154 of master image 152. These additional graphics and annotations are encoded into one or more overlying transparent graphic layers. Each transparent graphic layer 154 can be selectively visible or hidden within any screen display or printout of master image 152 within the graphic editor. The union of the various transparent graphic layers 154 over working image 122 combine all the graphic depictions and is saved as master image 152. At least one graphic layer 154 will include the geographic reference grid, if not already embedded in the photographic depictions from source image 112.

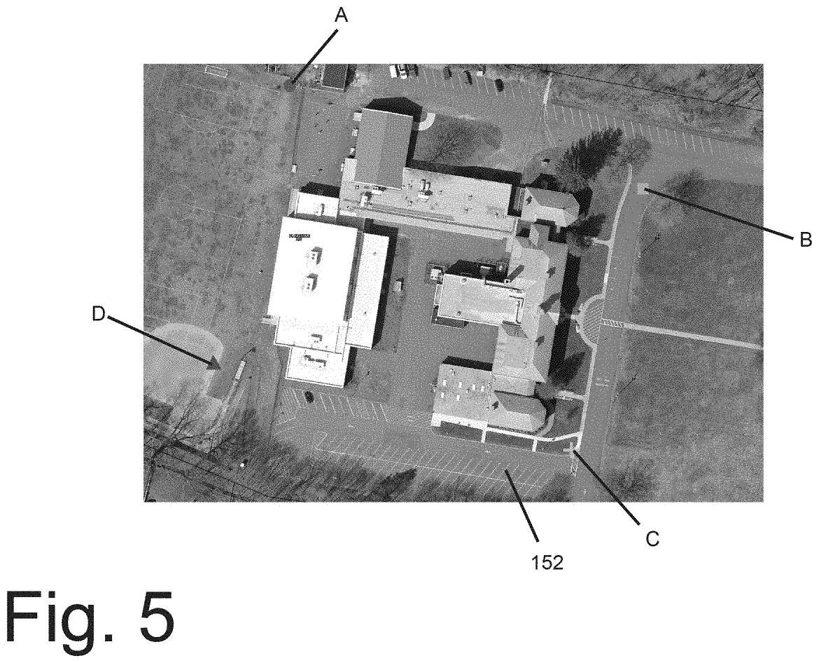

In creating master image 152, reference markers 164 are added to graphic layers 154 along with other imported graphics, annotations, comments and other related information (Step 160). Reference markers 164 are added to graphic layer 154 of master image 152 to identify each geographic anchor points A-D selected from the source image 112 and working image 122. Anchor point markers 164 can be marked by small graphic symbols, such as dots, triangles, squares, stars, crosses, etc. . . . added to each graphic layer 154 of master image 152. Anchor point markers 164 are precisely positioned within graphic layers 154 to exactly overlay the geographic anchor point depicted in source image 112 and working image 122. FIG. 5 illustrates an exemplary master image 152 generated from the working image 122 within the graphic editor. As shown in FIG. 5, four geographic anchor point marks are identified: 164A (red circle); 164B (green square); 164C (yellow cross); and 164D (purple triangle)—each corresponding to geographic anchor points A-D, respectively.

It should be noted that method 100 provides for the creation of multiple Supplemental Image 158 derived or copied from master image 152. Each supplemental image 158 contains the some anchor point markers as master image 152 with differing combinations of graphic layers 154 for a given working image 122. For example, multiple master images may be created illustrating separate floor plans of a multi-storied building or structure depicted within the source image. Other master images may illustrate only annotated information or designated routes through a given location. The extent of the graphics and annotations of any given master image is dictated by the intended use of the GRG within the GIS.

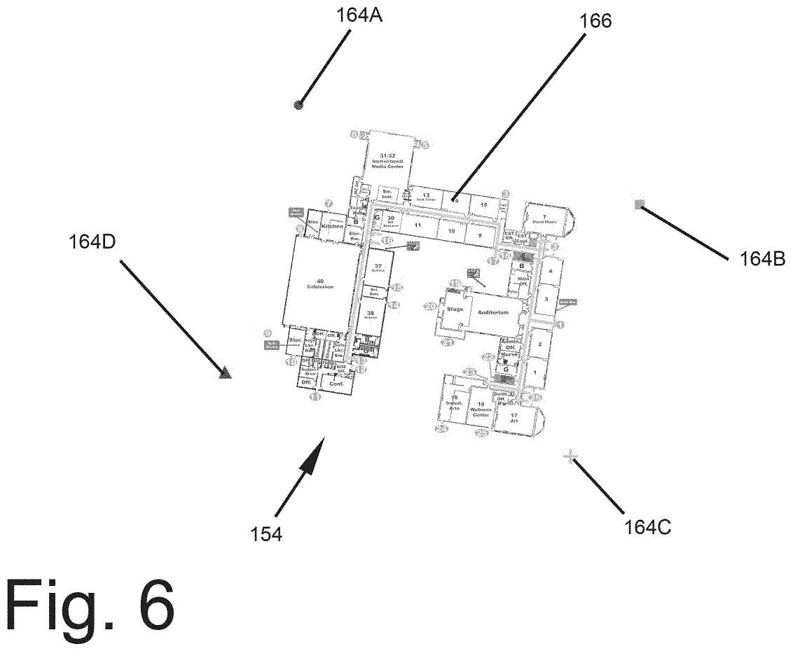

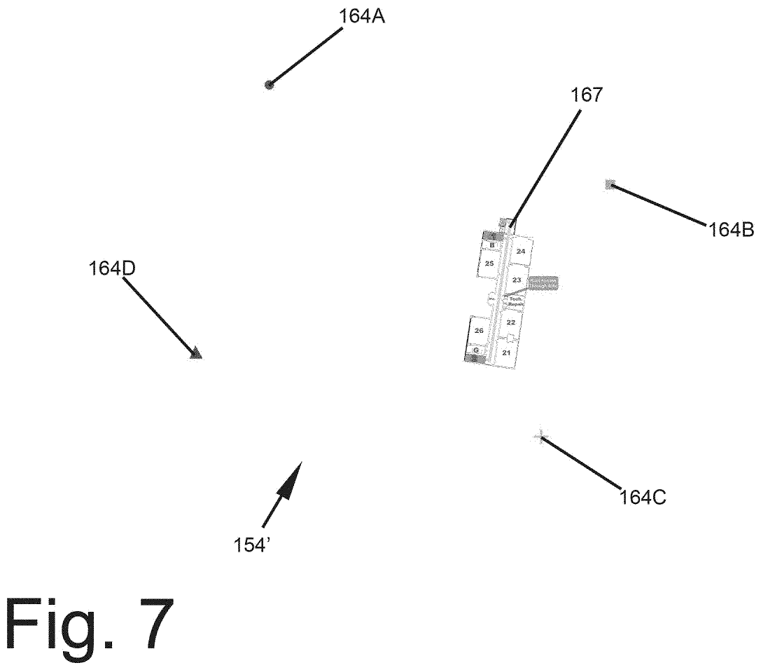

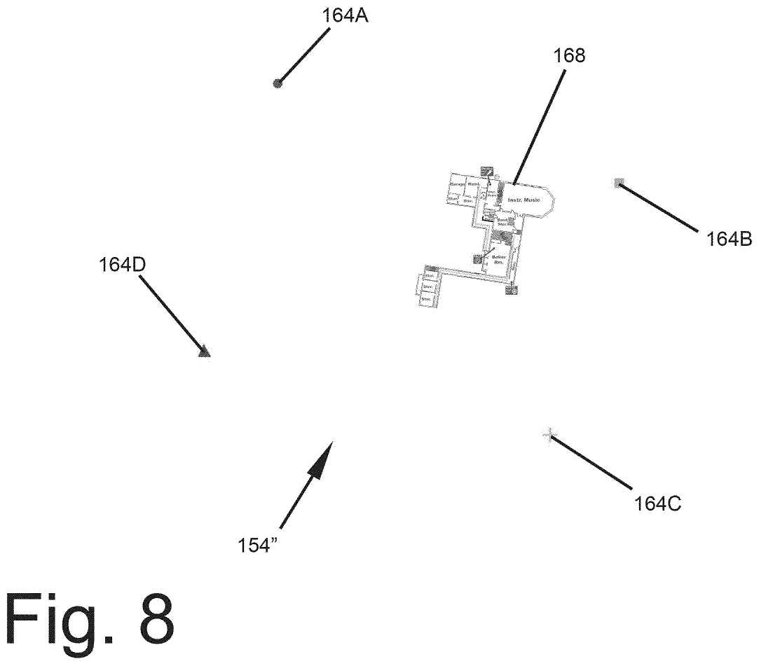

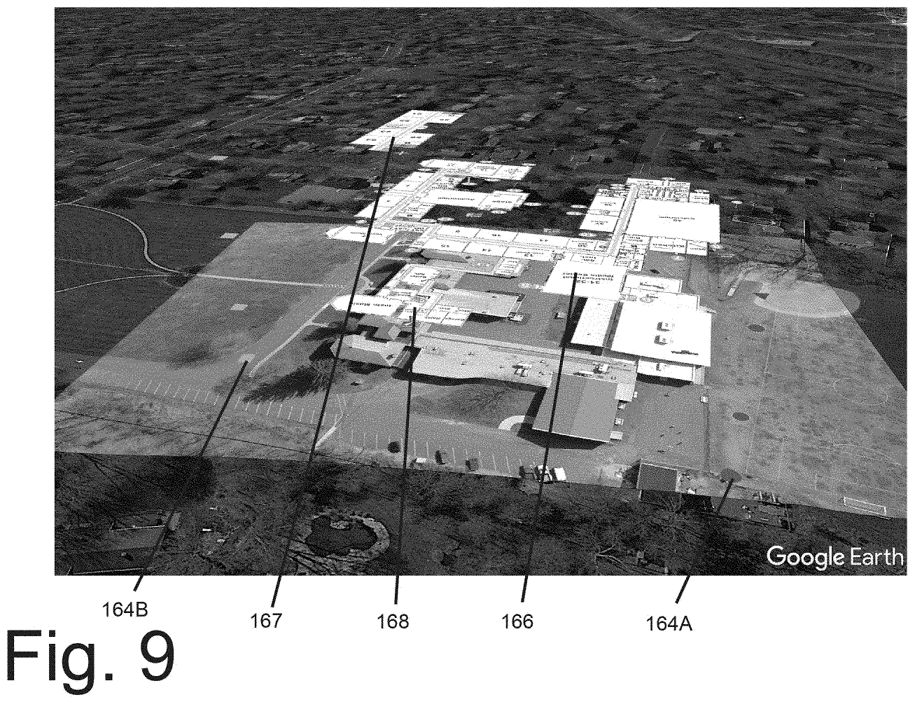

For example, FIGS. 6-9 illustrate various other exemplary graphic layers 154 containing additional imported graphics and annotations, which can be embedded within master image 152 or related supplemental images 158. FIG. 6 depicts a transparent graphic layer 154 containing a floor plan 166 for the first floor of the depicted school. FIG. 7 depicts another transparent graphic layer 154′ containing floor plan 167 for the second story of the depicted school. FIG. 8 depicts a transparent graphic layer 154″ containing a floor plan 168 for the basement of the depicted school. Each floor plan 166-168 is typically imported into the graphic editor and added into separate graphic layers 154. As shown, each of these transparent layers 154 includes the four geographic anchor markers 164A-164D, which are precisely mapped to each graphic layer to overlay each other and working image 122. In addition, graphic layers 154 include various annotations, directions and highlights pertaining to the depicted school. FIG. 9 is an exploded view of each of the transparent graphic layers of FIGS. 6-8 superimposed directly over working image 122 of the depicted school. As shown, each transparent layer is staggered to illustrate how the geographic anchor point marks 164A-D align and overlay the selected geographic anchor points A-D shown in master image 152 and other supplemental images 158.

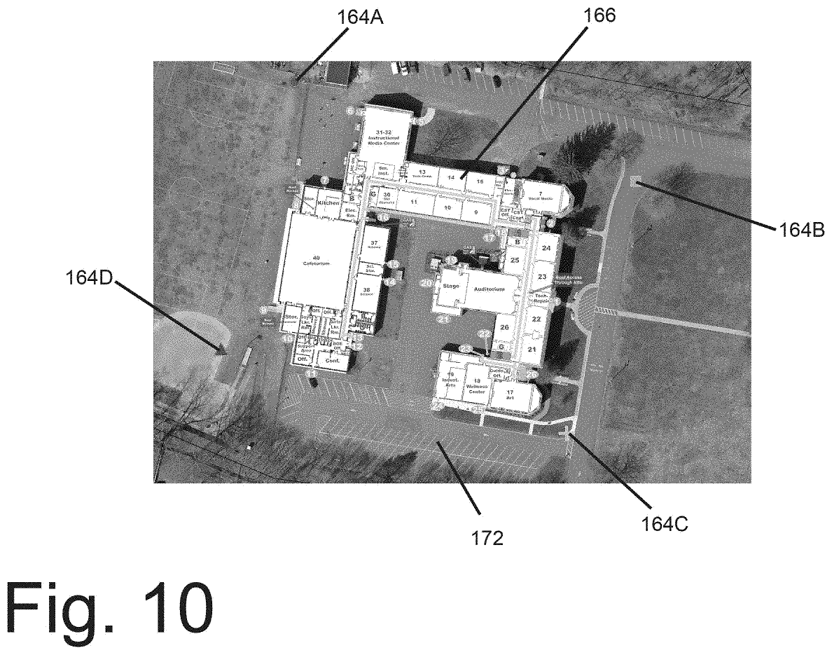

Once all the graphics and annotations have been added to graphic layers 154, master image 152 and related supplemental images 158 are saved as one or more final images 172 (Step 170). FIG. 10 illustrates a final image saved from the master image 152 with transparent layer 154 of FIGS. 5 and 6.

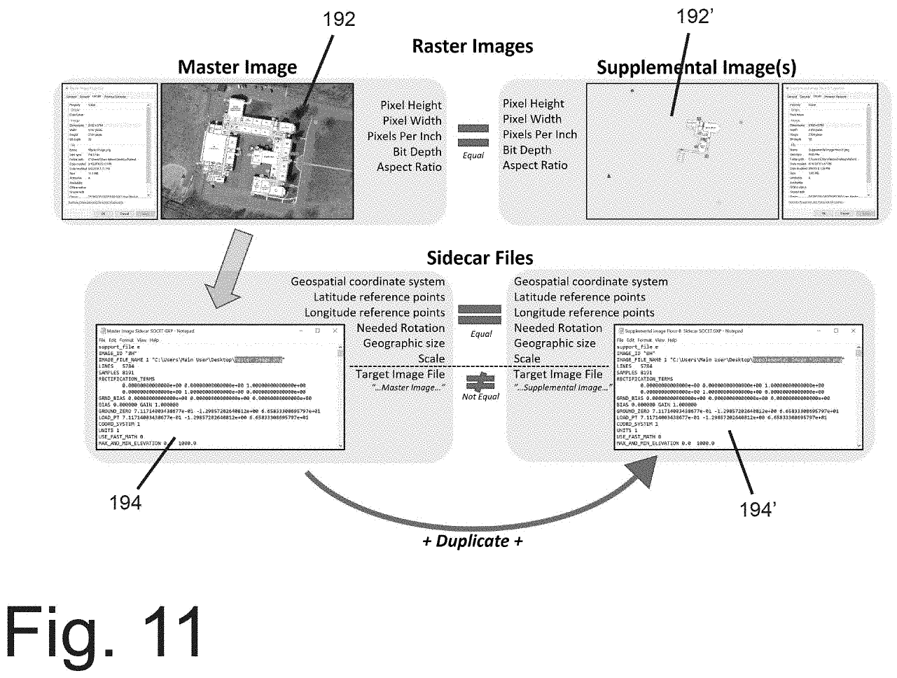

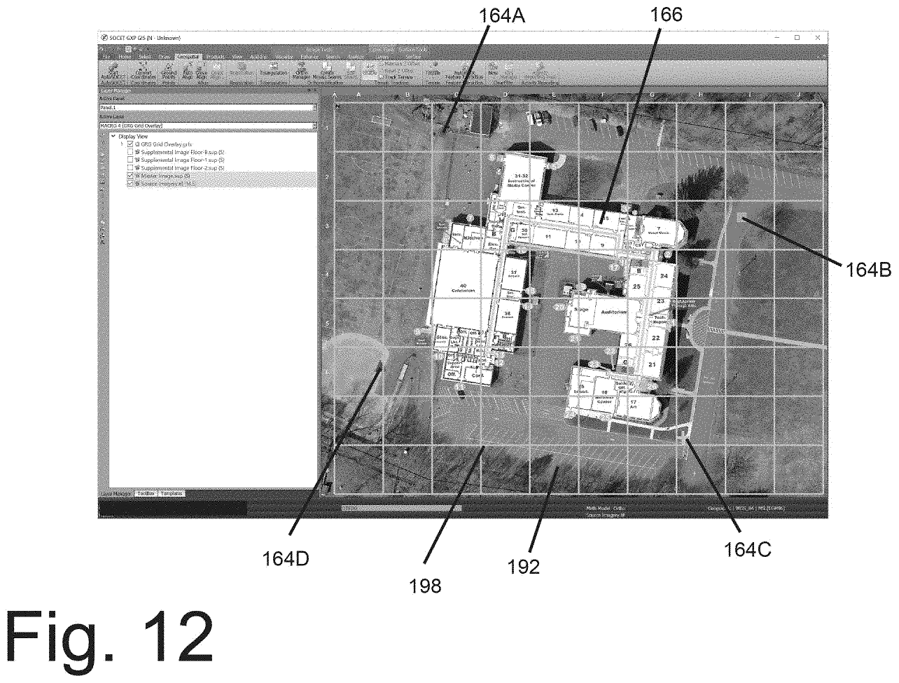

Final images 172 are exported back into a GIS platform (Step 170). Within the GIS platform, final images 172 are merged onto source image 112 aligning anchor point markers 164A-D of the final image to anchor points on the source image (Step 180). Once properly merged, the associated geospatial meta data from source image 112 is mapped onto master and related supplemental images 152 and 158, respectively, and saved as separate final images 192 (Step 190). Generally, this mapping is accomplished by copying any sidecar files 194 associated with source image 112 and linking them to each final image 192. As illustrated in FIG. 11, sidecar files 194 and each final image are linked by editing the file path within the sidecar file to identify the unique filename of final image, i.e., master image 152 or supplemental image 158. The GIS platform generally facilitates the mapping of the geospatial meta data, using conventional copy, cut and paste conventions. With the geospatial meta data encoded or linked, final image 192 is ready to use as a gridded reference graphic (“GRG”) within the GIS, with the full compliment of geospatial data available. FIG. 12 illustrates an exemplary final image 192 shown within a GIS platform, in this instance Socket GPX®, as a functional GRG. As shown, final image 192 shows the transparent graphic layer containing a floor plan 166 for the first floor of the depicted school from Fig. E superimposed over source image 112 and scalable reference grid 198 integrated and manipulated within the GIS platform.

One skilled in the art will note certain advantages provided by the method of this invention in creating gridded reference graphics. The method reduces the complexity and difficulty of creating, editing and manipulating large GIS image files within conventional GIS and utilizes the extensive, but commonly used, tools of conventional graphic software to streamline GRG creating. By creating a “dumb” image from a more complicated and sizable GIS source image, which can be easily imported and manipulated within convention graphic editing and creation software, graphics and annotation can be easily incorporated with faster rendering times. In addition, the use of conventional graphic software provides more tools and greater flexibility in creating enhancement graphics and annotations for GRGs than found in the more cumbersome GIS platforms. Once the “dumb” image is fully enhanced, the resulting master image can be exported back into the GIS and the geospatial metadata from the source image mapped into the master image creating the GRG having full functionality within the GIS.

It should be apparent from the foregoing that an invention having significant advantages has been provided. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

1. A method of creating an annotated gridded reference graphic for coordination of personnel and groups of personnel comprising;
selecting a source image of a desired location, the source image having associated geospatial meta data thereof;
generating a working image as a copy of the source image stripped of any geospatial meta data;
identifying geographic anchor points within the source image and working image;
importing the working image into a graphic editor;
creating a master image within the graphic editor from the working image having at least one overlaying graphic layer;
marking the identified geographic anchor point from the source image on the one graphic layer of the master working image;
exporting the master image into a geospatial information system;
merging the master image onto the source image to align the marked anchor points of the master image to the identified anchor points within the source image into a final image;
mapping the associated geospatial meta data from the source image to the final image to generate the gridded reference graphic from the final image.

2. The method of claim 1 wherein generating the working image includes screen printing the source image from a geospatial information system as a high resolution raster image.

3. The Method of claim 1 wherein identifying anchor points also includes identifying permanent structures and geographic features within the source image to be used as anchor points.

4. The method of claim 1 wherein importing the master working image to a vector editor also includes framing the size of the master working image to the size of the source image.
